(19) United States
(12) Patent Application Publication
(10) Pub. No.: US 2021/0283987 A1
(43) Pub. Date: Sep. 16, 2021

(54) ELECTRICAL HEATER WITH HEATING REGISTERS MADE OF PTC-ELEMENTS WHICH ARE COUPLED THERMALLY IN SERIES

(71) Applicant: Mahle International GmbH, Stuttgart (DE)

(72) Inventors: Simon Dangelmaier, Stuttgart (DE); Nicolas Edel, Soultz-Haut-Rhin (FR); Mathieu Hildenbrand, Colmar (FR); Marcel Huelss, Stuttgart (DE); Pascal Miss, Selestat (FR); Falk Viehrig, Stuttgart (DE); Robin Wanke, Stuttgart (DE); Denis Wiedmann, Fellbach (DE)

(21) Appl. No.: 17/198,241

(22) Filed: Mar. 10, 2021

(30) Foreign Application Priority Data
Mar. 11, 2020 (DE) 202020104986.0
Sep. 1, 2020 (DE) 102020211010.7

(51) Int. Cl. B60H 1/22; H05B 1/02

(52) U.S. Cl. CPC B60H 1/2218; B60H 1/2225; H05B 2203/02; B60H 2001/224; B60H 2001/2253; H05B 1/0236

(57) ABSTRACT

A heating arrangement may include at least one PTC heating device with at least one first PTC heating element. The PTC heating device includes at least one second PTC heating element that is distinct from the first PTC heating element, wherein the first and second PTC heating elements may be arranged in a through-flow direction next to one another. Alternatively, a further PTC heating device with at least one second PTC heating element that is distinct from the first PTC heating element may be provided, wherein the first and second PTC heating devices may be arranged in the through-flow direction next to one another.

### CROSS-REFERENCE TO RELATED APPLICATIONS

This application claims priority to German Patent Application No. DE 20 2020 104 986.0, field on Mar. 11, 2020 and German Patent Application No. DE 10 2020 211 010.7 filed on Sep. 1, 2020, the contents of both of which are hereby incorporated by reference in their entirety.

### TECHNICAL FIELD

The present invention relates to a heating arrangement, in particular for a motor vehicle. Apart from this, the invention relates to a method for operating such a heating arrangement and to an air-conditioning system of a motor vehicle having such a heating arrangement.

### BACKGROUND

From EP 1 780 061 B1 a generic heating arrangement with a first heating device having at least one first PTC heating element and a second heating device having at least one second PTC heating element is known. The two heating devices are arranged one after the other in through-flow direction. In order to be able to achieve different air temperatures, the heating arrangement can be flowed through by parallel air flows, wherein a first air flow flows only through the first heating device and a second air flow flowing parallel thereto, through the first and second heating device. The two heating devices can be either switched on or switched off.

From EP 1 452 357 B1 a heating arrangement is likewise known with a first heating device and a second heating device which are controllable separately from one another. By way of this, the generated quantity of heat for adjacent regions is to be separately meterable, in particular without flap control. There, too, the individual heating devices can be switched on or switched off for influencing an air flow through these.

Especially new generations of electric heating arrangements in electric vehicles are to be no longer operated in the 12V vehicle electrical system, but directly at the battery voltage level of 400V or in the future even 800V. When heating up a purely electric PTC heater, self-heating upon voltage application and reduction of its electrical resistance occurs up to a minimum (NTC range) occurs as a consequence of the characteristic of a PTC heating element, whereas the desired rapid down-regulation by way of the characteristic resistance increase occurs (PTC range). The transition between the NTC and the PTC range is referred to as turning point. This turning point is passed through upon every activation of the PTC heater so that the maximum current developing in the process has to be taken into account for the design of all components, in particular also conductor tracks, PCB, IGBT, connectors etc. Particularly during the heating-up process, a pulse width modulation (PWM) also leads to large voltage and current peaks which are caused by capacitances and inductances. In the process, the vehicle electrical system load can exceed impermissible values and lead to component failure.

Electric heating arrangements generally consist of simple heating registers or heating devices which consist of a single heating stage having one or multiple PTC heating elements and have a defined working point. In order to be able to completely cover a requested output curve, conventional components are thus designed for the maximum operating conditions with the consequence that during the normal operation unnecessary regulating strategies for reducing output are required which in turn can lead to an increased vehicle electrical system loading.

Furthermore, a cost-effective and reliable temperature measurement combined with a flow measurement can currently be realised merely by means of additional sensor technology and regulating equipment effort.

### SUMMARY

The present invention therefore deals with the problem of stating an improved or at least an alternative embodiment for a heating arrangement of the generic type, which in particular makes possible a comparatively simple individual regulation of a heating output with a reduction of the load in a vehicle electrical system at the same time.

According to the invention, this problem is solved through the subject matter of the independent claim(s). Advantageous embodiments form the subject matter of the dependent claim(s).

The present invention is based on the general idea of equipping a heating arrangement, for example in a motor vehicle, either with at least one PTC heating device having at least one first PTC heating element and with at least one second heating element and, in the through-flow direction, arranging these only next to one another or equipping the same with at least one PTC heating device having at least one first PTC heating element and with at least one further PTC heating device having at least one second PTC heating element, wherein the two PTC heating devices and thus also the PTC heating elements are arranged in the through-flow direction next to one another. The different PTC heating elements can be generally controlled jointly or separately. A joint control offers the major advantage that the at least two PTC heating elements, which can have a different reference temperature T_{Ref}, cover different temperature ranges. By way of this, a simply structured PTC heating device just like a simple operation of the same can be achieved since in particular a (control) device for the individual controlling/activating of the individual PTC heating elements can be omitted.

Practically, a device can be provided by means of which the at least two PTC heating elements are controllable independently of one another by means of the at least two PTC heating elements according to the first alternative in the PTC heating device or according to the second alternative in the two PTC heating devices. Here, independently means both alternatively and also simultaneously. This means that for example for a lower requested heating output merely the at least one first PTC heating element or the at least one second PTC heating element is activated while for a higher requested heating output both or all PTC heating elements can be activated. The individual PTC heating elements can also be controlled differently, for example by means of constant voltage or by means of pulse width modulation.

In an advantageous further development of the solution according to the invention, the at least one first PTC heating element has a first reference temperature T_{1Ref} and the at least one second PTC heating element a second reference temperature T_{2Ref}, where (T_{2Ref}−T_{1Ref})>5° Celsius. Here, the reference temperature of a PTC heating element is determined as follows: A typical diagram of a resistance profile as a function of the temperature of a PTC heating element initially shows a so-called NTC range (negative temperature coefficient) and subsequently a PTC range (positive temperature coefficient) The transition between the NTC range and the PTC range is the turning point, also briefly referred to as the starting temperature T_{A}. In the NTC range, the electrical resistance with rising temperature is reduced to a low point, namely the starting temperature T_{A}. With increasing temperature, the resistance rises again. Here, the reference temperature T_{Ref} is determined in that at the starting temperature T_{A} twice the resistance is taken and a parallel run from the same to the abscissa, until this parallel intersects the resistance curve. The reference temperature T_{Ref} of the respective PTC heating element, read off the abscissa, now lies on this point. Here, the resistance profile can be determined by a suitable mixture of the materials used for the PTC heating elements. By way of a delta of the two reference temperatures of the first and second PTC heating elements of greater than 5° Celsius or greater than 5 Kelvin, the major advantage can be achieved that the entire heating arrangement can generate all heating outputs better and with lower load for a vehicle electrical system. By way of such a ΔT_{Ref} of greater than 5° C., it can also be achieved that the individual PTC heating elements have different working ranges, wherein a working range of such a PTC heating element extends between a nominal temperature T_{N} and an end temperature T_{E}. Through the different reference temperatures, a steep increase of the resistance in the working range can be shifted in that the entire resistance curve is shifted. This is a major advantage in particular provided that at least one second PTC heating element has a higher reference temperature T_{2Ref} than the at least one first PTC heating element, since the air flowing through the heating arrangement and to be heated is then heated to a mixed temperature by the first PTC heating element and the second PTC heating element. Here, the air flowing through or generally the fluid flowing through is heated less via the at least one first PTC heating element than by the at least one second PTC heating element. By way of this it is possible to operate the entire heating arrangement with the two PTC heating elements in a respectively optimal working point or heating output range.

In a further advantageous embodiment of the solution according to the invention (T_{2Ref}−T_{1Ref})>10° Celsius or even >15° Celsius applies. Depending on the intended field of application it can be advantageous to increase a delta of the reference temperatures in order to be able to operate the respective PTC heating devices in their respective optimal working point or heating output range.

In a further advantageous embodiment of the heating arrangement according to the invention the device is designed in such a manner that at least the second PTC heating device is controllable by means of pulse width modulation. By way of this it is possible to continuously adjust via the pulse width modulation a heating output of 0 to 100%, as a result of which in particular highly diverse operating temperatures can be adjusted and not only a single one, as for example with a PTC heating device that can be merely switched on and off.

In a further advantageous embodiment of the heating arrangement according to the invention, at least a second PTC heating device has a size and/or form other than a first PTC heating device. Through different forms and sizes, the heating output that can be generated with the respective PTC heating device can likewise be influenced.

Practically, the PTC heating elements according to the first alternative, in which the at least one first PTC heating element and the at least one second PTC heating element are arranged in the same PTC heating device, form a common assembly, i.e. these are permanently joined to one another. This offers the major advantage that such an assembly can be easily produced and installed and because of the at least two types of different types of PTC heating elements, covers a specified output curve over a large area.

The present invention is based on the general idea of stating a method for operating a previously described heating arrangement having at least two different PTC heating elements, in which a heating output of at least one PTC heating element and thus indirectly also in the second alternative embodiment of the heating arrangement the further PTC heating device is adjusted by means of pulse width modulation. The other PTC heating element and thus indirectly also in the second alternative embodiment of the heating arrangement the PTC heating device can be operated with constant voltage, i.e. merely switched on and off. By way of this it is comparatively easily possible with the first PTC heating element(s) or in the second alternative embodiment of the heating arrangement with the PTC heating device to implement a constant heating stage and with the second PTC heating element(s) and thus in the second alternative embodiment of the heating arrangement with the further PTC heating device, a precision-tuneable PWM-controlled heating stage. In the case of a minimum requested heating output, for example merely one, preferentially the second, PTC heating element can thus be controlled via a pulse width modulation. For increasing the desired heating output, the pulse width can be enlarged until it amounts to 100%. When the heating arrangement comprises for example two PTC heating elements producing the same heating output, a heating output between 0 and 100% of the at least one second PTC heating element and thus maximally 50% of the heating output of the entire heating arrangement can be adjusted via the at least one pulse width-modulated PTC heating element, here the at least one second PTC heating element depending on the selected pulse width. Now, if this heating output is to be maintained, the at least one first PTC heating element can be switched on and operated with constant voltage while the at least one second PTC heating element is switched off. By switching off the at least one pulse width-modulated second PTC heating element, voltage and current peaks in particular and because of this a vehicle electrical system load are reduced. Purely theoretically it is obviously also conceivable to control both the at least one first and also the at least one second PTC heating element by means of pulse width modulation and thereby adjust the pulse widths of both PTC heating elements to 50% each. However this requires a higher control/regulating effort and increases the load for the vehicle electrical system.

When the heating output is to be increased further, the at least one first PTC heating element for example can be continued to be operated with constant voltage while the at least one second PTC heating element can be operated by means of pulse width modulation and in the process the pulse width increased from 0 to 100%.

In the case of a flattening output request, the at least one activated second PTC heating element can be again reduced in its output, i.e. in its pulse width. Through the superimposition of the heating output of the first and second PTC heating elements, the entire working range can be optimally covered without the heating arrangement having to be designed for comparatively high vehicle electrical system loads of two simultaneously pulse width-modulated PTC heating elements, since regardless of the selected heating output range only the at least one second PTC heating element is always pulse width-modulated while the at least one first PTC heating element constitutes a constant heating stage.

Here, the method according to the invention functions independently of the selected alternative of the heating arrangement according to the invention. Thus, only one PTC heating device having at least one first and one second PTC heating element can be provided, or a PTC heating device and a further PTC heating device can be provided, wherein in the PTC heating device only first PTC heating elements and in the second PTC heating device only second PTC heating elements are provided. Purely theoretically, the method according to the invention also functions with a heating arrangement having a PTC heating device with at least one first and one second PTC heating element, and a second such PC heating device likewise having at least one first and one second PTC heating element.

Alternatively it is obviously also possible that the at least one first and the at least one second PTC heating element are not controlled separately and independently of one another but jointly, as a result of which through for example different reference temperatures of the first and second PTC heating element a large temperature range can be covered. Obviously, the at least two PTC heating elements in this case can be controlled constantly or by means of pulse width modulation. “Constantly” in this case means with the same voltage/current or pulse-width 100%.

In an advantageous further development of the solution according to the invention of the method according to the invention, exclusively the at least one second PTC heating element is subjected in a first range to a pulse width of 0%≤W≤100% and thus a heating output between H₀≤H≤H₁ adjusted. When the heating output H reaches the heating output H₁, i.e. H=H₁, the pulse width W of the at least one second PTC heating element is regulated down to 0% and thus the at least one second PTC heating element switched off, while the at least one first PTC heating element is operated with constant voltage without pulse width modulation and H=H₁ thereby maintained. In a second range, the at least one first PTC heating element is now continued to be operated with constant voltage and the at least one second PTC heating element again subjected to a pulse width of 0%≤W≤100% by means of pulse width modulation. By way of this, a heating output between H₁≤H≤H₂ can be adjusted. By means of such a method according to the invention, the entire heating output range can thus be very precisely adjusted and covered, wherein mainly a type of PTC heating elements requires an increased regulating effort, i.e. via the pulse width modulation. Here it is obviously clear that by means of such a method further PTC heating devices, for example a two-stage heating arrangement, can be additionally embodied.

In the second alternative of the heating arrangement according to the invention, in which in the PTC heating device only one or more first PTC heating elements and in the further PTC heating device only one or more second PTC heating elements are arranged, exclusively the further PTC heating device with its second PTC heating elements can be subjected in a first range with a pulse width of 0%≤W≤100% and thus a heating output between H₀≤H≤H₁ adjusted. When the heating output H reaches the heating output H₁, i.e. H=H₁, the pulse width W of the at least one second PTC heating element is regulated down in the further PTC heating device to 0 and thus the further PTC heating device switched off, while the PTC heating device is operated with constant voltage without pulse width modulation and H=H₁ thereby maintained. In a second range, the PTC heating device is continued to be operated with constant voltage and the further PTC heating device with its second PTC heating elements again subjected to a pulse width of 0%≤W≤100% by means of pulse width modulation.

Practically it can be provided that at least two PTC heating devices are arranged in the through-flow direction one behind the other. Purely theoretically, the two PTC heating devices can also be arranged next to one another in the through-flow direction. Here, the second PTC heating device likewise comprises a first PTC heating element and at least one second PTC heating element which can be controlled jointly or independently of one another.

Furthermore, the present invention is based on the general idea of equipping an air conditioning system of a motor vehicle with such a heating arrangement and thereby transfer the previously mentioned advantages with respect to reduction of the voltage and current peaks. By way of this, in particular a vehicle electrical system load, which would occur with two pulse width-modulated PTC heating elements, can also be significantly reduced. By means of such a heating arrangement, the PTC heating elements employed therein can also be designed smaller since it is a multi-stage heating arrangement and it is thus no longer necessary that the individual PTC heating elements are designed for the maximum conditions.

Further important features and advantages of the invention are obtained from the subclaims, from the drawings and from the associated figure description by way of the drawings.

It is to be understood that the features mentioned above and still to be explained in the following cannot only be used in the respective combination stated but also in other combinations or by themselves without leaving the scope of the present invention.

Preferred exemplary embodiments of the invention are shown in the drawings and are explained in more detail in the following description, wherein same reference numbers relate to same or similar or functionally same components.

### BRIEF DESCRIPTION OF THE DRAWINGS

It shows, in each case schematically

FIG. 1 shows a heating arrangement according to the invention in accordance with a first alternative,

FIG. 2 shows a resistance-temperature profile of a possible PTC heating element,

FIG. 3 shows a heating output of a pulse width-modulated second PTC heating element,

FIG. 4 shows a heating output of a first PTC heating element that is not pulse width-modulated,

FIG. 5 shows a cumulated heating output of the first PTC heating elements and of the second heating elements,

FIG. 6 shows a heating arrangement according to the invention in accordance with a further embodiment,

FIG. 7 shows a resistance-temperature profile of two different PTC heating elements,

FIG. 8 shows a heating arrangement corresponding to a second alternative.

### DETAILED DESCRIPTION

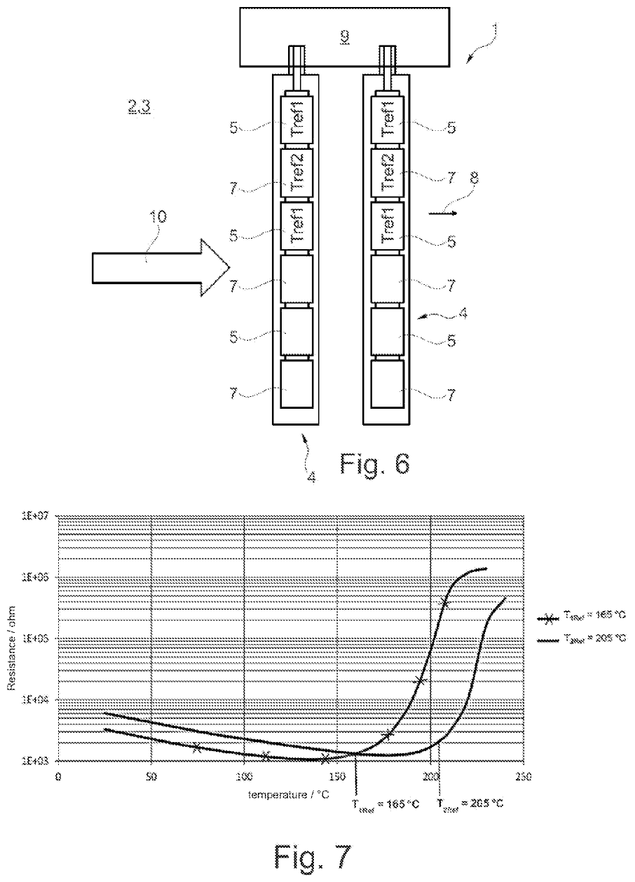

According to FIGS. 1, 6 and 8, a heating arrangement 1 according to the invention, which can be arranged for example in an air conditioning system 2 of a motor vehicle 3, comprises a PTC heating device 4 with at least one, here multiple first PTC heating elements 5 and according to the first alternative embodiment shown in FIGS. 1 and 6, having at least one, here likewise multiple second PTC heating elements 7. According to FIG. 6, a PTC heating device 4 of identical design is additionally provided in the through-flow direction 8 thereafter.

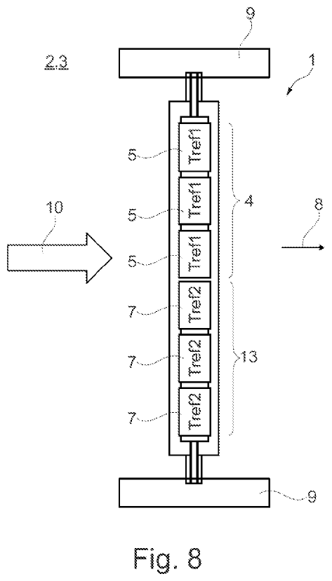

According to the second alternative embodiment of the heating arrangement 1 according to the invention shown in FIG. 8, a further PTC heating device 13 having at least one second PTC heating element 7 is provided, wherein the two PTC heating devices 4, 13 are arranged in the through-flow direction 8 next to one another. In this case, only first PTC heating elements 5 are arranged in the PTC heating device 4 and only second PTC heating devices 7 in the further PTC heating device 13.

The two types of PTC heating elements 5, 7 are arranged in the through-flow direction 8 next to one another, in particular alternatingly (see FIG. 1) and are therefore simultaneously circulated about by a fluid flow to be heated, for example air 10.

The at least one first and the at least one second PTC heating element 5, 7 in the PTC heating device 4 and/or in the further PTC heating device 13 cannot be controlled separately and independently of one another, but jointly, as a result of which, for example through different reference temperatures T_{1Ref} and T_{2Ref} of the first and second PTC heating element 5, 7, a large temperature range can be covered. Obviously, the at least two PTC heating elements 5, 7 of the PTC heating devices 4, 13 can be controlled constantly or by means of pulse width modulation in this case. “Constantly” in this case means with the same voltage/current or a pulse width of 100%.

Likewise provided can be a device 9, for example a control/regulating device, via which the two PTC heating elements 5, 7 or the two groups of first and second PTC heating elements 5, 7, are controllable independently of one another, in particular alternatively but also simultaneously. This offers the major advantage that depending on requested heating output H either the first or the second PTC heating elements 5, 7 or all PTC heating elements 5, 7 can be activated.

Through the independent controlling of both PTC heating elements 5, 7 or their cumulative controlling each with different outputs it is possible for the first time to completely cover an entire requested output curve with respect to a heating output H and not only, as in the past, individual working points or extracts of the heating output range, as was possible with conventional electric heaters that could only be switched on and off.

In an advantageous further development of the heating arrangement 1 according to the invention, the first PTC heating elements 5 have a first reference temperature T_{1Ref} and the second PTC heating elements 7 a second reference temperature T_{2Ref}, wherein (T_{2Ref}−T_{1Ref})>5° Celsius or >5 Kelvin applies.

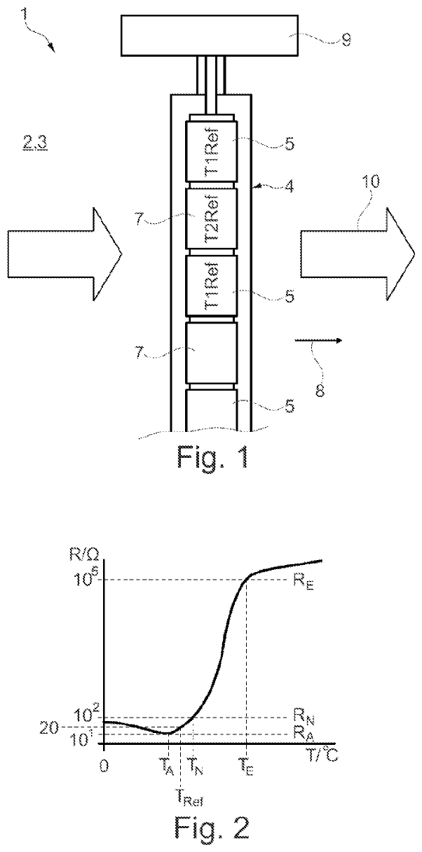

Here, the reference temperature T_{Ref} is determined as follows: according to FIG. 2, an exemplary resistance-temperature curve of a possible PTC heating element 5, 7 is shown. Up to a starting temperature T_{A}, such a PTC heating element 5, 7 has an NTC range (negative temperature coefficient), in which the resistance R falls with increasing temperature T, until the resistance R at the starting temperature T_{A} has reached its low point. T_{A} is also referred to as the temperature at the turning point. Following this, the PTC heating element 5, 7 upon a further heating changes into the PTC range (positive temperature coefficient), in which the resistance R greatly increases with the temperature T. Now, the reference temperature T_{Ref} is determined with each PTC heating element 5, 7 in that at the starting temperature T_{A} twice the resistance according to FIG. 2, i.e. in the example R=20 ohm, is assumed and a point of intersection with the resistance-temperature curve in the PTC range searched at this ohmic value. The associated reference temperature T_{Ref} is read off the abscissa at this point. By arranging two PTC heating elements 5, 7 that are distinct with respect to their reference temperature T_{Ref} it is possible to operate the two PTC heating elements 5, 7 nearer to their optimal working point and because of this improve both the output of the heating arrangement 1 and also minimise any voltage or current peaks that may occur.

Here, for example (T_{2Ref}−T_{1Ref})>10° Celsius or 15° Celsius preferably applies, wherein for example the reference temperature T_{1Ref} of the first PTC heating elements 5 can be less than or equal to 155° Celsius while the reference temperature T_{2Ref} of the second PTC heating elements 7 can be greater than or equal to 165° Celsius.

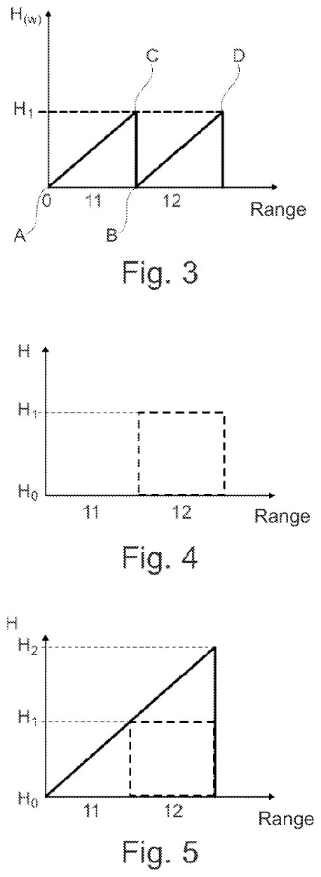

In a further advantageous embodiment of the solution according to the invention, the at least one device 9 is designed in such a manner that it can control at least or exclusively the second PTC heating elements 7 by means of pulse width modulation. Such a pulse width modulation is shown in the FIG. 3 in different diagrams, wherein on the abscissa the heating output in percent and on the ordinate the pulse width w likewise in percent is plotted.

In the diagrams of FIGS. 3 to 5, the heating outputs H of two PTC heating elements 5, 7 are recorded, which produce the same heating output. Within each case fully activated PTC heating elements 5, 7, these produce 100% of their output each which corresponds to 50% of the heating output of the heating arrangement 1 each.

Looking at FIG. 3, pulse width-modulated second PTC heating elements 7 are noticeable in this diagram in the case of which the pulse width-dependent heating output H in the first and second range 11, 12 in the points A and B with 0% modulated pulse width w is 0% while the heating output H in the points C and D with 100% pulse width w there amounts to 100% of the heating output H of the second PTC heating elements 7. This corresponds to 50% of the heating output H₂ of the entire heating arrangement 1.

In the diagram of FIG. 4, the first PTC heating elements 5 are shown in the case of which no pulse width modulation whatsoever is carried out so that these can be merely switched on and off and then produce either 0 or 100% heating output of the first PTC heating elements 5. Here, the first PTC heating elements 5 in the first range 11 are shown in the switched-off state and in the second range 12 in the switched-on state. Here, in the switched-on state they produce 100% of the heating output H of the first PTC heating elements 5, i.e. H₁, which corresponds to 50% of the heating output H₂ of the entire heating arrangement 1 with simultaneously activated first and second PTC heating elements 5, 7.

Now combining these two differently controlled PTC heating elements 5, 7, the diagram of FIG. 5 is obtained, in which in a first range 11, via which 0 to 50% of the heating output H of the heating arrangement 1 can be covered, exclusively the second PTC heating elements 7 are subjected to a pulse width between 0%≤W≤100%. By way of this, a heating output H can be achieved of H₀≤H≤H₁, wherein H₁ corresponds to 50% of the heating output H₂ of the heating arrangement 1.

Here, the second PTC heating elements 7 can be switched off or their pulse width W run down to 0% and subsequently merely the first PTC heating element 5 activated. In this case, the heating output H remain at H₁. Now, if the heating output is to be increased further, the first PTC heating elements 5 in a second range 12 can be continued to be operated with constant voltage while the second PTC heating elements 7 are subjected to a pulse width of 0%≤w≤100% and thereby a heating output H₁≤H≤H₂ adjusted. Because of this, a superimposition of the first PTC heating elements 5 operated with constant voltage and of the second PTC heating elements 7 controlled with pulse width modulation takes place. Because of this, a complete and finally controllable covering of a heating output curve is comparatively easily possible.

Here it is obviously conceivable that the individual first PTC heating elements 5 or the individual second PTC heating elements 7 can have different sizes or forms or have the same size and the same form. Likewise it is obviously conceivable that besides the PTC heating device 4 at least one such PTC heating device 4 can be additionally arranged in the through-flow direction 8 after the PTC heating device 4, as is shown in FIG. 6, wherein this PTC heating device 4 also comprises at least one further first and second PTC heating element 5, 7 and wherein (T_{2Ref}−T_{1Ref}) is at least >5° Celsius applies.

Likewise it is obviously conceivable that besides the PTC heating device 4 at least one further PTC heating device 13 is additionally arranged in the through-flow direction 8 next to the PTC heating device 4, as is shown in FIG. 8, wherein (T_{2Ref}−T_{1Ref}) is at least >5° Celsius applies.

Here, the further PTC heating device 13 can also comprise at least one second PTC heating element 7 and the PTC heating device 4 at least one first PTC heating element 5, so that in the PTC heating device 4 only first PTC heating elements 5 and in the further PTC heating device 13 only second PTC heating elements 7 are arranged, wherein the PTC heating device 4 and the further PTC heating device 13 or the at least one first PTC heating element 5 and the at least one second PTC heating element 7 can be controlled jointly or independently of one another.

By way of this, a further finer regulation of the heating output of the heating arrangement 1 is possible. Here, the PTC heating elements 5, 7 can be controlled constantly or by means of pulse width modulation.

In FIG. 7, resistance-temperature curves of a possible first PTC heating element 5 and of a possible second PTC heating element 7 are shown. The first PTC heating element 5 has a reference temperature T_{1Ref} of 165° C., while the second PTC heating element 7 has a reference temperature T_{2Ref} of 205° C. Even with constant controlling of both PTC heating elements 5, 7, this produces different temperature ranges with different optimal working points. In this case (T_{2Ref}−T_{1Ref})=40° C. applies.

With the heating arrangement 1 according to the invention and the operating method according to the invention it is possible to reduce the dimensions of the current-carrying components, for example conductor tracks and also voltage and current peaks and thereby the vehicle electrical system load, as a result of which the entire vehicle electrical system can be designed for lower loads and thus cost-effectively. Through the individual combinability of the individual PTC heating elements 5, 7 a boost function for brief maximum outputs can also be comparatively easily made available, here through the pulse-width modulated second PTC heating elements 7, without the entire vehicle electrical system having to be designed for comparatively high loads.

In addition to this, a temperature and volumetric flow monitoring is also possible since the multi-stage PTC heating arrangement 1 besides the functionality of heating, can also use the individual PTC heating elements 5, 7 as measuring elements for determining physical quantities.

1. A heating arrangement comprising at least one PTC heating device with at least one first PTC heating element, wherein one of:
the PTC heating device includes at least one second PTC heating element that is distinct from the first PTC heating element, wherein the first and second PTC heating elements are arranged in a through-flow direction next to one another; or
a further PTC heating device with at least one second PTC heating element that is distinct from the first PTC heating element is provided, wherein the first and second PTC heating devices are arranged in the through-flow direction next to one another.

2. The heating arrangement according to claim 1, wherein the first and second PTC heating elements are controllable independently of one another via a controller.

3. The heating arrangement according to claim 1, wherein the at least one first PTC heating element has a first reference temperature T_{1Ref} and the at least one second PTC heating element a second reference temperature T_{2Ref}, wherein (T_{2Ref}−T_{1Ref})>5° C.

4. The heating arrangement according to claim 3, wherein one of:
(T_{2Ref}−T_{1Ref})>10° C.; or
(T_{2Ref}−T_{1Ref})>15° C.

5. The heating arrangement according to claim 2, wherein the controller controls at least the at least one second PTC heating element via pulse width modulation.

6. The heating arrangement according to claim 3, wherein T_{1Ref}<155° C.

7. The heating arrangement according to claim 3, wherein T_{2Ref}≥165° C.

8. The heating arrangement according to claim 1, wherein at least two second PTC heating elements and at least two first PTC heating elements are arranged alternatingly in the PTC heating device and next to one another in the through-flow direction.

9. The heating arrangement according to claim 1, wherein at least two PTC heating devices are arranged in the through-flow direction one behind the other.

10. The heating arrangement according to claim 1, wherein at least one second PTC heating element has at least one of a size and a form other than a first PTC heating element.

11. A method for operating a heating arrangement having at least one PTC heating device with at least one first PTC heating element, comprising adjusting a heating output of at least one PTC heating elements via pulse width modulation; wherein one of:
the PTC heating device includes at least one second PTC heating element that is distinct from the first PTC heating element, wherein the first and second PTC heating elements are arranged in a through-flow direction next to one another; or
a further PTC heating device with at least one second PTC heating element that is distinct from the first PTC heating element is provided, wherein the first and second PTC heating devices are arranged in the through-flow direction next to one another.

12. The method according to claim 11, wherein at least one first PTC heating element is operated without pulse width modulation and at least one second PTC heating element with pulse width modulation.

13. The method according to claim 12, wherein:
in a first range exclusively the at least one second PTC heating element is controlled with a pulse width of 0%≤W≤100% such that a heating output within the first range is adjusted;
at the end of the first range, the pulse width w is adjusted to 0% and the at least one second PTC heating element is switched off and the at least one first PTC heating element is operated with constant voltage without pulse width modulation; and
in a second range the at least one first PTC heating element is continued to be operated with constant voltage and the at least one second PTC heating element is subjected to a pulse width of 0%≤w≤100% such that a heating output of adjusted.

14. An air conditioning system of a motor vehicle comprising a heating arrangement including at least one PTC heating device with at least one first PTC heating element, wherein one of:
the PTC heating device includes at least one second PTC heating element that is distinct from the first PTC heating element, wherein the first and second PTC heating elements are arranged in a through-flow direction next to one another; or
a further PTC heating device with at least one second PTC heating element that is distinct from the first PTC heating element is provided, wherein the first and second PTC heating devices are arranged in the through-flow direction next to one another.

15. The air conditioning system according to claim 14, wherein the first and second PTC heating elements are controllable independently of one another via a controller.

16. The air conditioning system according to claim 14, wherein the at least one first PTC heating element has a first reference temperature T_{1Ref} and the at least one second PTC heating element a second reference temperature T_{2Ref}, wherein (T_{2Ref}−T_{1Ref})>5° C.

17. The air conditioning system according to claim 16, wherein one of:
(T_{2Ref}−T_{1Ref})>10° C.; or
(T_{2Ref}−T_{1Ref})>15° C.

18. The air conditioning system according to claim 15, wherein the controller controls at least the at least one second PTC heating element via pulse width modulation.

19. The air conditioning system according to claim 16, wherein T_{1Ref}<155° C.

20. The air conditioning system according to claim 16, wherein T_{2Ref}>165° C.
